(19) United States
(12) Patent Application Publication
(10) Pub. No.: US 2025/0244179 A1
(43) Pub. Date: Jul. 31, 2025

(54) Method for determining the temperature of a semiconductor switch and inverter circuit

(71) Applicant: SEG Automotive Germany GmbH, Stuttgart (DE)

(72) Inventors: Nima SAADAT, Stuttgart (DE); Mohd Ali SHADMAN, Stuttgart (DE); Murugaperumal DEVARAJA, Stuttgart (DE)

(21) Appl. No.: 19/037,357

(22) Filed: Jan. 27, 2025

(30) Foreign Application Priority Data
Jan. 30, 2024 (DE) 102024102629.4

(51) Int. Cl. G01K 7/00; G01K 3/00; H02P 29/68

(52) U.S. Cl. CPC G01K 7/00; G01K 3/005; H02P 29/68

(57) ABSTRACT

A method for determining a temperature of a semiconductor switch which has a control terminal, a current input terminal connected to a potential terminal by a diode, a capacitor, a resistor and a current source, and a current output terminal. includes determining a DESAT voltage applied to the capacitor at a first point in time and at a second point in time, determining a load current flowing between the current input terminal and the current output terminal of the semiconductor switch at the first point in time, determining a drain-source resistance prevailing between the current input terminal and the current output terminal of the semiconductor switch at the first point in time from the DESAT voltage and the load current determined at the first point in time and at the second point in time, and determining the temperature of the semiconductor switch from the drain-source resistance and the load current.

### CROSS-REFERENCE TO RELATED APPLICATIONS

This application claims priority to German Patent Application No. 10 2024 102 629.4 filed Jan. 30, 2024 which is hereby incorporated by reference.

### TECHNICAL FIELD

The present disclosure relates to a method for determining a temperature of a semiconductor switch and an inverter circuit for carrying out the method.

### BACKGROUND

The junction temperature of semiconductor switches such as IGBTs (isolated gate bipolar transistor), MOSFETs (metal oxide semiconductor field effect transistor) or SiC (silicon carbide) MOSFETs can be determined using a temperature sensor that is integrated into the housing or attached to the outside of the housing. A temperature sensor is usually integrated into the power modules and can be used to estimate the die temperatures inside the power modules. The measured temperature can be used for overtemperature protection, e.g. by reducing the power (de-rating).

When using sensors, additional insulation and signal routing to the control board is required; if a high voltage is switched using the semiconductor switch, a signal isolator is also required. Adding a current sensor to each semiconductor switch requires additional space, which is not always available, especially for TO (transistor outline) housings that are connected to busbars or the circuit board.

The transmission of the measured signal from the power board to the control system is very complex due to the insulation and also the interference immunity. The response time of a sensor is also relatively long.

Determining the temperature of a MOSFET using the R_{DSon} (drain-source on resistance) of the MOSFET is also possible, but this requires complicated circuits to measure the voltage across the switch, especially for high-voltage switches. The measurement is also highly dependent on the drain current.

### SUMMARY

According to the disclosure, a method for determining a temperature of a semiconductor switch and an inverter circuit for carrying out the method are proposed with the features of the independent patent claims. Advantageous embodiments are the subject of the dependent claims and the following description.

The disclosure utilizes a simple circuit (which is also referred to below as a DESAT circuit) to determine a temperature of a semiconductor switch. The semiconductor switch has a control terminal, a current input terminal and a current output terminal. The current input terminal is connected to a potential terminal via a diode, a terminal of a capacitor, a resistor component and a current source. The other terminal of the capacitor is connected to ground. The potential terminal can be connected to a positive electrical potential or a positive supply voltage. The current input terminal of the semiconductor switch can be connected to the cathode of the diode, so that a current flow from the semiconductor switch into the DESAT circuit is blocked. The temperature can be estimated by measuring the voltage applied to the capacitor at different times.

This is particularly advantageous, as the concept of desaturation (DESAT) protection known per se for semiconductor switches can be used for the circuit configuration described with a minimum of additional components, so that the effort and costs are considerably reduced. Commercially available gate driver ICs (integrated circuits, hereinafter referred to as gate drivers) can have a DESAT terminal to which the drain terminal of the semiconductor switch is connected via a DESAT circuit as described above. The gate driver can thus monitor the semiconductor switch for overcurrent or short circuit and switch it off in the event of a fault. In the context of the disclosure, the temperature is now also estimated by a special evaluation of voltages in the DESAT circuit.

Specifically, the DESAT voltage applied to the capacitor is determined at a first point in time and at a second point in time, and the load current flowing between the current input terminal and the current output terminal of the semiconductor switch at the first point in time is determined. The load current is defined here as the current that flows through the semiconductor switch and a load, such as a phase winding of an electrical machine, and is switched by the semiconductor switch. Further, the drain-source resistance prevailing between the current input terminal and the current output terminal of the semiconductor switch at the first point in time is determined from the DESAT voltage determined at the first point in time and the load current determined at the second point in time, and the temperature of the semiconductor switch is determined from the drain-source resistance and the load current. Conveniently, the load current can be measured.

The disclosure overcomes the disadvantages of the prior art and, in particular, leads to a number of advantages. Neither the temperature nor R_{DSon} need to be measured in order to measure the temperature of the semiconductor switch; instead, this can be derived very simply from the DESAT voltage. No temperature sensor is required on or near the switch. The available short-circuit protection (DESAT) is used with a minimum of additional components, so that costs are significantly reduced. The measurement has a short response time.

For the transmission of the measurement signals to the evaluation electronics (control unit), a data interface can be used advantageously with appropriately equipped gate drivers, so that no additional signal transmission is then required. The insulation of the measured signal is then also provided by the insulation of the gate driver.

The proposed concept can be used for online monitoring of the temperature of the semiconductor switch and online fault detection.

No additional space is required as no temperature sensor needs to be added to each switch. This is particularly advantageous for TO housings that are connected to the busbars or the printed circuit board, as there is usually little installation space available. Furthermore, the disclosure can be advantageously used for power modules that contain several parallel chips.

The proposed method is hardly dependent on the load current and the temperature of the DESAT circuit.

The disclosure has particular advantages for semiconductor switches which are used in an inverter circuit to control an electrical machine, in particular in vehicles, for example as a drive or traction drive, since large currents flow here and evaluation is therefore simplified. As is known, an inverter circuit or a power converter circuit is used to connect AC voltage terminals of the electrical machine to DC voltage terminals of a network, such as a vehicle network, and to convert the voltages accordingly. The inverter circuit has a number of semiconductor switches for this purpose, each of which can be opened (non-conductive) and closed (conductive) in accordance with a control signal. The semiconductor switches can comprise MOSFETs and IGBTs, for example gallium nitride (GaN) or silicon carbide (SIC) FETs. The vehicle network can be a low-voltage network or a high-voltage network, whereby in the latter case a low-voltage network is also present to supply the components of the inverter circuit with electricity. The high-voltage network and low-voltage network can be coupled in the vehicle via a suitable DC/DC converter. The nominal voltage level of the high-voltage network (hereinafter also referred to as the high-voltage level) can, for example, be significantly higher than a permissible touch voltage of e.g. 60 V, e.g. up to several hundred volts. For example, high-voltage levels of 400 V or 800 V are often used in current electric vehicles. The nominal voltage level of the low-voltage network can, for example, correspond to standard vehicle low voltages of 12 V or 24 V, for example.

In one embodiment, the inverter circuit can have a number of high-side semiconductor switches and a number of low-side semiconductor switches and at least one gate driver for one or more of the semiconductor switches in each case. The gate driver is used to apply a control signal to a control terminal of a semiconductor switch (e.g. gate terminal of MOSFET). In particular, the gate driver has a DESAT terminal.

Further advantages and embodiments of the disclosure are shown in the description and the accompanying drawing.

The disclosure is illustrated schematically in the drawing by means of embodiment examples and is described below with reference to the drawing.

### BRIEF DESCRIPTION OF THE DRAWINGS

FIG. 1 shows a circuit arrangement with a semiconductor switch, a gate driver and a DESAT circuit, in embodiments.

FIGS. 2a and 2b show a sinusoidal load current curve and associated DESAT voltages as measured, in embodiments.

FIG. 3 shows a section of an inverter circuit, in embodiments.

FIG. 4 shows a section of a further inverter circuit, in embodiments.

### DETAILED DESCRIPTION

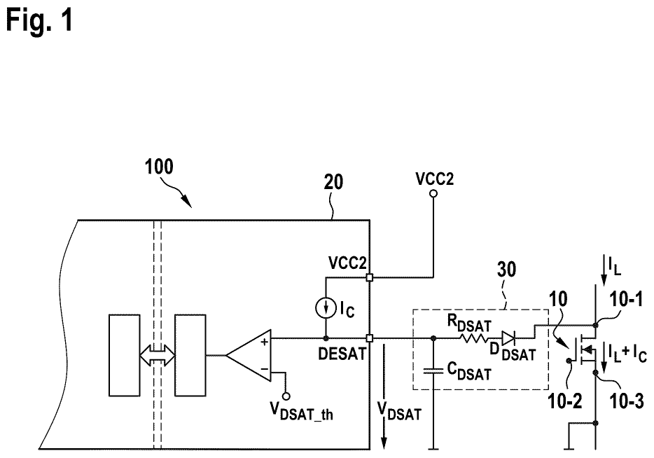

FIG. 1 shows a schematic representation of a circuit arrangement that can serve as a starting point for the disclosure, labelled 100. The circuit arrangement has a semiconductor switch 10 and a gate driver 20 for controlling (and monitoring) the semiconductor switch 10. In particular, the circuit arrangement can be part of an inverter circuit.

The semiconductor switch 10 has a current input terminal 10-1, a control terminal 10-2 and a current output terminal 10-3. It can have other terminals not shown, such as a Kelvin source terminal and the like. In the present case, the semiconductor switch 10 is illustrated as a MOSFET or SiC MOSFET, so that the terminals are usually and hereinafter referred to as drain, gate and source. However, it can also be an IGBT, in which case the terminals are usually referred to as collector, gate and emitter.

The gate driver 20 comprises a terminal or pin DESAT, via which the semiconductor switch 10 can be monitored when correctly connected. Internal components of the gate driver 20 are only partially indicated and partially omitted, but the DESAT terminal is usually connected via a (typically internal) current source (here I_{C}) via a VCC2 terminal to a voltage supply (here VCC2) and to a comparator (here operational amplifier), which compares the voltage V_{DSAT} applied to the DESAT pin with an internal threshold voltage (here V_{DSAT_th}) and, depending on the comparison result, initiates protective measures. For example, it switches a circuit containing the semiconductor switch (e.g. an inverter) to a safe state.

A DESAT circuit 30 is arranged between the current input terminal or drain terminal 10-1 of the semiconductor switch 10 and the DESAT terminal DESAT of the gate driver 20. The DESAT circuit 30 has a resistor component (hereinafter also simply a resistor) R_{DSAT}, a blanking capacitor C_{DSAT} and a diode D_{DSAT}. A cathode of the diode is connected to the drain terminal 10-1 of the semiconductor switch 10 to be monitored. It should be noted at this point that the diode can also be connected in parallel to the drain terminals of several semiconductor switches to be monitored. In series with the diode D_{DSAT} and the resistor component R_{DSAT} is a terminal of the capacitor C_{DSAT}, the other terminal of which is connected to ground.

When the circuit arrangement 100 is switched on, the current source I_{C} charges the blanking capacitor C_{DSAT} and the diode D_{DSAT} is conductive. The current strength of I_{C} can be adjustable, but is also fixed in some gate drivers. In normal operation, the voltage of the capacitor is connected via the diode to the voltage across the semiconductor switch 10. In the event of a short circuit or generally a very high load current through the semiconductor switch, the diode becomes non-conductive and the DESAT voltage V_{DSAT} applied to the DESAT terminal or the capacitor is then quickly charged to and above the threshold voltage (by the current source), which triggers the DESAT protection function on the gate driver side and usually leads to the semiconductor switch being switched off. The switch-off process can be performed as a soft turn-off to prevent damage to the switch due to the overvoltage that occurs during switch-off.

In such a circuit arrangement, the drain-source resistance R_{DSon} can also be derived from available measured values in accordance with embodiments of the disclosure. In principle, R_{DSon} is calculated using the following equations:

$${V}_{DSAT} = {I}_{C} \times {R}_{DSAT} + {V}_{F , DSAT} + {V}_{DSon} \qquad ( 1 )$$

$${V}_{DSon} = {V}_{DSAT} - {I}_{C} \times {R}_{DSAT} - {V}_{F , DSAT} \qquad ( 2 )$$

$${R}_{DSon} = \frac{{V}_{DSon}}{{I}_{L} + {I}_{C}} = \frac{{V}_{DSAT} - {I}_{C} \times {R}_{DSAT} - {V}_{F , DSAT}}{{I}_{L} + {I}_{C}} \qquad ( 3 )$$

V_{F,DSAT}: Forward voltage of the diode
V_{DSon}: Drain-source voltage
I_{L}: Load current (usually measurable) when semiconductor switch conducts
I_{L}+I_{C}=I_{D}: Drain current (usually not measurable; can be determined if I_{L} and I_{C} are known)

However, the forward voltage V_{F,DSAT} of the diode and the resistance value of the component R_{DSAT} are strongly temperature-dependent, which negatively influences the accuracy of the calculated value R_{DSon}.

However, if R_{DSon} is determined at short intervals for two different load current values, the influence of temperature can be eliminated.

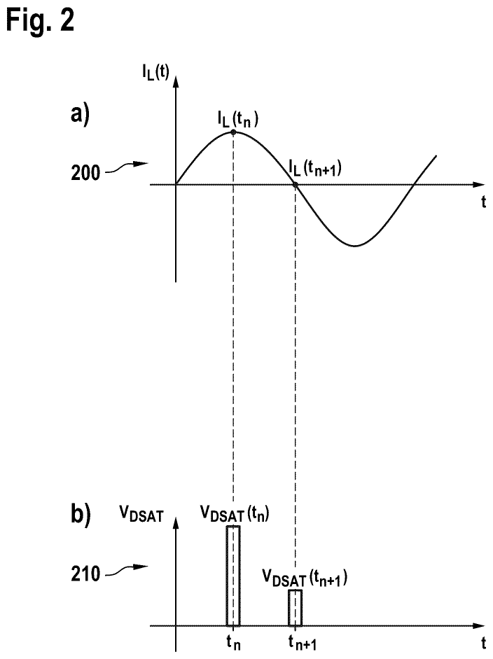

FIG. 2a shows in a diagram 200 schematically a curve of the load current I_{L}(t) over the time t for a typical sinusoidal case, e.g. during motorized operation of an electrical machine, and FIG. 2b shows in a diagram 210 associated values of the measurable DESAT voltage V_{DSAT}. The values of the DESAT voltage V_{DSAT}(tₙ) and V_{DSAT}(tₙ₊₁) are sh for a peak value at tₙ and a zero crossing at tₙ₊₁ of the load current.

Typical inverter circuits normally already have a load or phase current measurement, so that no additional current sensor is required. However, this sensor can be used in embodiments of the disclosure and is then arranged on the load side. If this is a high-voltage network, for example, the output of the sensor must be isolated and then sent to the evaluating control unit, which is usually located in a low-voltage network.

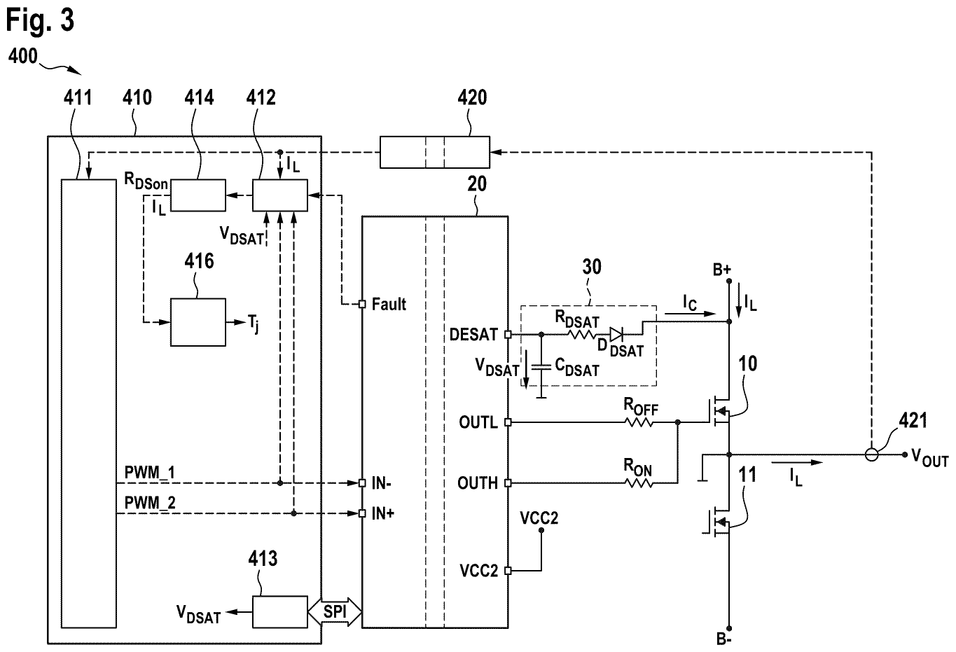

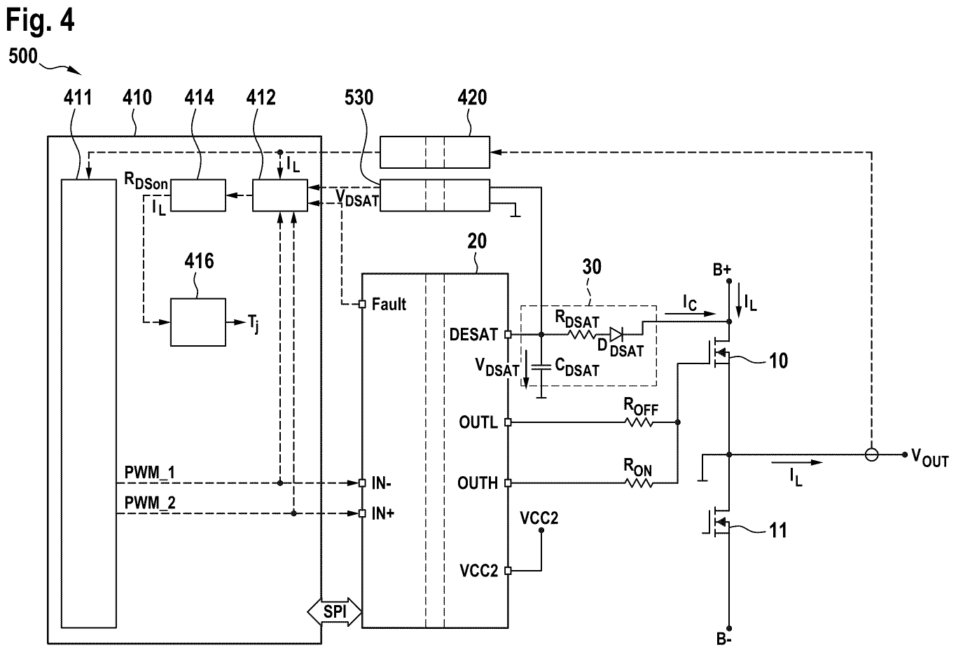

V_{DSAT} can be measured in the gate driver (see also FIG. 3) or with an external voltage measurement circuit (see also FIG. 4); as this measurement also takes place in the high-voltage network, it must also be isolated from the low-voltage network.

A first measurement takes place at a first point in time tₙ, whereby a first drain current I_{L}(tₙ)+I_{C} flows through the semiconductor switch 10. The following then applies:

$${R}_{DSon} ( {t}_{n} ) = \frac{{V}_{DSAT} ( {t}_{n} ) - {I}_{C} \times {R}_{DSAT} ( {t}_{n} ) - {V}_{F , DSAT} ( {t}_{n} )}{{I}_{L} ( {t}_{n} ) + {I}_{C}} = \frac{{V}_{DSAT} ( {t}_{n} ) - {V}_{drop} ( {t}_{n} )}{{I}_{L} ( {t}_{n} ) + {I}_{C}} \qquad ( 4 )$$

with a voltage drop V_{drop}(tₙ) across the DESAT resistor component and the DESAT diode of

$${V}_{drop} ( {t}_{n} ) = {I}_{C} \times {R}_{DSAT} ( {t}_{n} ) + {V}_{F , DSAT} ( {t}_{n} ) \qquad ( 5 )$$

If the first measurement is carried out at the peak of the current waveform, or at a sufficiently high value, this is favorable for the signal/noise ratio.

In the next step, the measurement takes place at a different point in time tₙ₊₁ of the load current cycle (see FIGS. 2a-2b). The following applies:

$${R}_{DSon} ( {t}_{n} + 1 ) = \frac{{V}_{DSAT} ( {t}_{n + 1} ) - {I}_{C} \times {R}_{DSAT} ( {t}_{n + 1} ) - {V}_{F , DSAT} ( {t}_{n + 1} )}{{I}_{L} ( {t}_{n + 1} ) + {I}_{C}} = \frac{{V}_{DSAT} ( {t}_{n + 1} ) - {V}_{drop} ( {t}_{n + 1} )}{{I}_{L} ( {t}_{n + 1} ) + {I}_{C}} \qquad ( 6 )$$

$${V}_{drop} ( {t}_{n + 1} ) = {I}_{C} \times {R}_{DSAT} ( {t}_{n + 1} ) + {V}_{F , DSAT} ( {t}_{n + 1} ) \qquad ( 7 )$$

If, in one embodiment, the second measurement is carried out at a point in time when the load current is as low as possible, but the semiconductor switch is still conducting, for example at or near the zero crossing (see FIGS. 2a-2b), this results in a very simple evaluation, since the load current is very low or almost zero at the second time, I_{L}(tₙ₊₁)≈0 and so the voltage drop across the switch is negligible, i.e. V_{DSon}(tₙ₊₁)≈0 (I_{C} is usually very small, e.g. in the milliampere range, and therefore negligible here).

In particular, it must be ensured that the semiconductor switch 10 is conductive at the first point in time tₙ and at the second point in time tₙ₊₁. Advantageously, a situation arises in which the DESAT voltage determined at the first point in time tₙ is greater, in particular significantly greater, e.g. by a factor of 100 or more, than the DESAT voltage determined at the second point in time tₙ₊₁.

This follows from (1):

$${V}_{DSAT} ( {t}_{n + 1} ) = {I}_{C} \times {R}_{DSAT} ( {t}_{n + 1} ) + {V}_{F , DSAT} ( {t}_{n + 1} ) = {V}_{drop} ( {t}_{n + 1} ) \qquad ( 8 )$$

If the two measurements are very close to each other in terms of duration (e.g. a few 10-100 ms), it can be assumed that the temperature of the semiconductor switch, the DESAT diode and the DESAT resistor component has not changed significantly. Therefore, no change in V_{drop} IS expected for two consecutive measurements tₙ, tₙ₊₁ within one electrical cycle. Then applies:

$${V}_{drop} ( {t}_{n} ) = {V}_{drop} ( {t}_{n + 1} ) \qquad ( 9 )$$

The effect of V_{drop} on the measurement can therefore be neglected, so that the following applies:

$$\begin{matrix}{R}_{DSon} ( {I}_{L} ( {t}_{n} ) , {T}_{j} ) = \frac{{V}_{DSAT} ( {t}_{n} ) - {I}_{C} \times {R}_{DSAT} ( {t}_{n} ) - {V}_{F , DSAT} ( {t}_{n} )}{{I}_{L} ( {t}_{n} ) + {I}_{C}} = \frac{{V}_{DSAT} ( {t}_{n} ) - {V}_{DSAT} ( {t}_{n + 1} )}{{I}_{L} ( {t}_{n} ) + {I}_{C}} \\ \approx \frac{{V}_{DSAT} ( {t}_{n} ) - {V}_{DSAT} ( {t}_{n + 1} )}{{I}_{L} ( {t}_{n} )}\end{matrix} \qquad ( 10 )$$

This results in the drain-source resistance R_{DSon}(I_{L}(tₙ), Tⱼ) for a specific load current I_{L}(tₙ) and a specific junction temperature Tⱼ from two consecutive measurements of V_{DSAT} (i.e. V_{DSAT}(tₙ) for a first point in time and V_{DSAT}(tₙ₊₁) for a second point in time) in the event that the load current I_{L}(tₙ₊₁) is (essentially) zero during the second measurement or at the second point in time. Since the following usually applies I_{L}(tₙ)>>I_{C}, I_{C} can be neglected here.

The temperature characteristic of the drain-source resistor of the semiconductor switch R_{DSon}(I_{L}(tₙ),Tⱼ) i.e. the dependence on load current and temperature, can be measured in advance and stored in a memory device, such as a local non-volatile memory or a remote memory (such as a cloud) as a table or a characteristic map for given temperatures and load currents. Therefore, if the drain-source resistance and the associated load current are known, the temperature Tⱼ can be determined.

If the temperature Tⱼ of the semiconductor switch 10 is above a temperature threshold value, a measure can be taken, such as a current reduction or opening the semiconductor switch 10 (switching to non-conducting) or switching a circuit comprising the semiconductor switch (e.g. inverter) to a safe state.

In FIG. 3, a section of an embodiment of an inverter circuit is schematically shown in a circuit diagram form and labelled 400. The inverter circuit can be used to control an electrical machine (not shown), for example in a vehicle. The inverter circuit is set up to monitor a semiconductor switch 10, which in the present case is arranged in a half-bridge arrangement as a so-called high-side switch with a further semiconductor switch 11 as a low-side switch. However, it should be noted that the low-side switch 11 can also be monitored additionally or alternatively.

The inverter circuit 400 has a gate driver 20, a DESAT circuit 30 and a control unit 410. The control unit 410 can be a local control unit of the inverter circuit, for example an electric motor control unit (MCU), or all data can be transmitted to a remote control unit or a cloud and then analyzed remotely. In this example, the use of a local control unit is shown.

On the supply side, the half-bridge arrangement is connected to a connection B+ and a connection B−, which can be supplied, for example, from a DC link and/or a high-voltage network of a vehicle. The center tap of the half-bridge arrangement is connected as load connection V_{OUT} to a stator or phase winding of the electrical machine, for example.

A desired load current I_{L} can be generated in the stator winding by selectively controlling the semiconductor switches 10 and 11. In the example shown, a load current measurement is realized by means of a current measuring circuit 420, which can be connected, for example, to a corresponding current sensor 421 in the phase winding or its supply line. Depending on the type of current sensor 421, the current measuring circuit 420 can also be omitted and the sensor can be connected directly to the control unit 410, for example if the current sensor 421 is electrically isolated from the half-bridge arrangement (e.g. in the case of a current sensor based on the Hall effect).

The control unit 410 contains a logic unit 411, which implements the functionality of the control unit 410 in terms of programming.

The modules used to implement embodiments of the disclosure are shown separately and, in particular, independently of the logic unit 411. As explained, they can also be implemented elsewhere or in other control units. However, implementation in an MCU is advantageous, since much of the required information or data is available there anyway.

In particular, the logic unit 411 determines PWM signals PWM_1 and PWM_2 for controlling the semiconductor switches 10 and 11, which are routed to inputs IN− and IN+ of the gate driver 20 and to a processing unit 412. The gate driver 20 outputs the control signals (in this case separate signals for ON and OFF) for the semiconductor switch 10 at outputs OUTH and OUTL, which are connected to the gate 10-2 via current limiting resistors R_{ON} and R_{OFF}. A separate gate driver(s) (not shown) can be provided for the semiconductor switch 11, which can be constructed and connected in the same way as the gate driver 20. Alternatively, corresponding additional terminals (not shown) in the gate driver 20 can be provided for the semiconductor switch 11.

The processing unit 412 is used to acquire different input signals, as shown, which originate, for example, from the gate driver 20 and the current measurement circuit 420 or within the control unit 410. The PWM signals PWM_1 and PWM_2 are used to determine suitable first and second points in time for the measurement, for example peak and zero crossing. The PWM_1 and PWM_2 signals can also be used to derive when the semiconductor switches 10 and 11 are conducting or non-conducting.

Data required for the further process, such as the load current I_{L}, are transferred to a calculation module 414 and/or a temperature determination module 416.

Data can be exchanged digitally between the gate driver 20 and the control unit 410 by means of a digital data interface 413, e.g. an SPI interface, whereby the DESAT voltage V_{DSAT} is included in the present example. The DESAT voltage V_{DSAT} is transferred to the processing unit 412 (e.g. for synchronization with the measured current values) and then to the calculation module 414, which uses it to calculate the drain-source resistance R_{DSon}, as described above, and transfers it to the temperature determination module 416.

The processing unit 412 (or the data interface 413) can also be used to receive an error signal from the gate driver 20 (fault output). An error status of the gate driver can then also be read out by means of the data interface 413 for further analysis. In the event of a fault or the receipt of a fault signal, the DESAT values should not be used to monitor the status of the switch.

The temperature determination module 416 is used to determine a current junction temperature Tⱼ of the semiconductor switch 10 from R_{DSon} and I_{L} as explained before.

In FIG. 4, a section of a further embodiment 500 of an inverter circuit is shown schematically and like a circuit diagram, which essentially corresponds to the embodiment 400 according to FIG. 3. In contrast to the embodiment shown in FIG. 3, here the DESAT voltage is not transmitted digitally from the gate driver 20 via the data interface 413, but is measured and transmitted by a separate DESAT voltage measuring circuit 530.

As explained, the half-bridge arrangement can be arranged in a high-voltage network, whereas the control unit 410 and other modules in both FIGS. 3 and 4 are supplied from a low-voltage network. A separation or isolation between the high-voltage network and the low-voltage network is shown by dashed lines in the gate driver 20 and the modules 420, 530.

1. A method for determining a temperature (Tⱼ) of a semiconductor switch (10),
the semiconductor switch (10) having a control terminal (10-2), a current input terminal (10-1) and a current output terminal (10-3),
wherein the current input terminal (10-1) is connected to a potential terminal (VCC2) via a diode (D_{DSAT}), a terminal of a capacitor (C_{DSAT}), a resistor component (R_{DSAT}) and a current source (I_{C}),
wherein the other terminal of the capacitor (C_{DSAT}) is connected to ground, the method comprising the following steps:
a) Determining a DESAT voltage (V_{DSAT}) applied to the capacitor (C_{DSAT}) at a first point in time (tₙ) and at a second point in time (tₙ₊₁);
b) Determining a load current (I_{L}) flowing between the current input terminal (10-1) and the current output terminal (10-3) of the semiconductor switch (10) at the first point in time (tₙ);
c) Determining a drain-source resistance (R_{DSon}) prevailing between the current input terminal (10-1) and the current output terminal (10-3) of the semiconductor switch (10) at the first point in time (tₙ) from the DESAT voltage (V_{DSAT}) and the load current (I_{L}) determined at the first point in time (tₙ) and the second point in time (tₙ₊₁);
d) Determining the temperature (Tⱼ) of the semiconductor switch (10) from the drain-source resistance (R_{DSon}) and the load current (I_{L}).

2. The method according to claim 1, wherein the DESAT voltage (V_{DSAT}) applied to the capacitor (C_{DSAT}) is detected by means of a DESAT voltage measuring circuit (530).

3. The method according to claim 1, wherein the current input terminal (10-1) is connected to a DESAT terminal (DESAT) of a gate driver (20) via the diode (D_{DSAT}), the terminal of the capacitor (C_{DSAT}) and the resistor component (R_{DSAT}), and wherein the DESAT terminal (DESAT) of the gate driver (20) is connected to the potential terminal (VCC2) via a current source (I_{C}) of the gate driver (20).

4. The method according to claim 3, wherein the DESAT voltage (V_{DSAT}) applied to the capacitor (C_{DSAT}) is determined within the gate driver (20).

5. The method according to claim 1, wherein the semiconductor switch (10) is conductive at the first point in time (tₙ) and at the second point in time (tₙ₊₁).

6. The method according to claim 1, wherein the time between the first point in time (tₙ) and the second point in time (tₙ₊₁) is at most 1 ms or at most 10 ms or at most 25 ms or at most 50 ms or at most 100 ms or at most 1000 ms.

7. The method according to claim 1, wherein the DESAT voltage (V_{DSAT}) determined at the first point in time (tₙ) is greater than the DESAT voltage (V_{DSAT}) determined at the second point in time (tₙ₊₁).

8. The method according to claim 1, wherein the second point in time (tₙ₊₁) corresponds to a point in time with the lowest possible current or a zero crossing of a load current waveform (200).

9. The method according to claim 1, wherein the first time point (tₙ) corresponds to a point in time with the highest possible current or a peak point of a load current waveform (200).

10. The method according to claim 1, wherein the temperature (Tⱼ) of the semiconductor switch (10) is determined from the drain-source resistance (R_{DSon}) and the load current (I_{L}) by means of a characteristic map or a lookup table.

11. The method according to any claim 1, further comprising:
performing a measure when the temperature (Tⱼ) of the semiconductor switch (10) is above a temperature threshold.

12. The method according to claim 1, wherein the temperature (Tⱼ) of a high-side switch and/or a low-side switch of a half-bridge arrangement is determined.

13. An inverter circuit (400) for driving an electrical machine, comprising at least one semiconductor switch (10) and a control device (410),
wherein the at least one semiconductor switch (10) has a control terminal (10-2), a current input terminal (10-1) and a current output terminal (10-3),
wherein the current input terminal (10-1) is connected to a potential terminal (VCC2) via a diode (D_{DSAT}), a terminal of a capacitor (C_{DSAT}), a resistor component (R_{DSAT}) and a current source (I_{C}),
wherein the other terminal of the capacitor (C_{DSAT}) is connected to ground,
wherein the inverter circuit (400) is configured to
a) Determine a DESAT voltage (V_{DSAT}) applied to the capacitor (C_{DSAT}) at a first point in time (tₙ) and at a second point in time (tₙ₊₁);
b) Determine a load current (I_{L}) flowing between the current input terminal (10-1) and the current output terminal (10-3) of the semiconductor switch (10) at the first point in time (tₙ);
c) Determine a drain-source resistance (R_{DSon}) prevailing between the current input terminal (10-1) and the current output terminal (10-3) of the semiconductor switch (10) at the first point in time (tₙ) from the DESAT voltage (V_{DSAT}) and the load current (I_{L}) determined at the first point in time (tₙ) and the second point in time (tₙ₊₁);
d) Determine the temperature (Tⱼ) of the semiconductor switch (10) from the drain-source resistance (R_{DSon}) and the load current (I_{L}).

14. The inverter circuit according to claim 13, comprising a gate driver (20) with a DESAT terminal (DESAT),
wherein the current input terminal (10-1) of the semiconductor switch (10) is connected to the DESAT terminal (DESAT) of the gate driver (20) via the diode (D_{DSAT}), the terminal of the capacitor (C_{DSAT}) and the resistor component (R_{DSAT}),
wherein the DESAT terminal (DESAT) of the gate driver (20) is connected to a potential terminal (VCC2) via the current source (I_{C}).

15. The inverter circuit according to claim 14, further comprising a DESAT voltage measuring circuit (530) for determining the DESAT voltage (V_{DSAT}), which is electrically isolated connected to the control device (410).

16. The inverter circuit according to claim 14, wherein the gate driver (20) is connected to the control unit (410) via a digital data interface (413) for transmitting the DESAT voltage (V_{DSAT}).
